(19) United States
(12) Patent Application Publication
(10) Pub. No.: US 2014/0278339 A1
(43) Pub. Date: Sep. 18, 2014

(54) Computer System and Method That Determines Sample Size and Power Required For Complex Predictive and Causal Data Analysis

(71) Applicants: Konstantinos (Constantin) F. Aliferis, Astoria, NY (US); Lawrence Fu, Long Island City, NY (US); Alexander Statnikov, New York, NY (US); Yin Aphinyanaphongs, New York, NY (US)

(72) Inventors: Konstantinos (Constantin) F. Aliferis, Astoria, NY (US); Lawrence Fu, Long Island City, NY (US); Alexander Statnikov, New York, NY (US); Yin Aphinyanaphongs, New York, NY (US)

(21) Appl. No.: 14/215,967

(22) Filed: Mar. 17, 2014

Related U.S. Application Data
(60) Provisional application No. 61/792,151, filed on Mar. 15, 2013.

(51) Int. Cl. G06N 3/08

(52) U.S. Cl. CPC G06N 3/08
USPC 703/22

(57) ABSTRACT

Established methods for statistical “power-size” analysis for statistical modeling are geared toward statistical hypothesis testing, and have serious shortcomings in modern complex predictive and causal modeling applications where the determination of sample size is affected by parameters not addressed by the standard statistical power-size analysis. The present invention provides a method and computer-implemented system for determining sufficient sample size for training predictive or causal models for a given application field or distribution type and desired performance level taking into account the critical factors that affect the needed sample size. The invention can be applied to practically any field where predictive modeling or causal modeling are desired.

Benefit of U.S. Provisional Application No. 61/792,151 filed on Mar. 15, 2013 is hereby claimed.

### BACKGROUND OF THE INVENTION

### Field of Application

The field of application of the invention is data analysis especially as it applies to (so-called) “Big Data” (see sub-section 1 “Big Data and Big Data Analytics” below). The methods, systems and overall technology and knowhow needed to execute data analyses is referred to in the industry by the term data analytics. Data analytics is considered a key competency for modern firms [1]. Modern data analytics technology is ubiquitous (see sub-section 3 below “Specific examples of data analytics application areas”). Data analytics encompasses a multitude of processes, methods and functionality (see sub-section 2 below “Types of data analytics”).

Data analytics cannot be performed effectively by humans alone due to the complexity of the tasks, the susceptibility of the human mind to various cognitive biases, and the volume and complexity of the data itself Data analytics is especially useful and challenging when dealing with hard data/data analysis problems (which are often described by the term “Big Data”/“Big Data Analytics” (see sub-section 1 “Big Data and Big Data Analytics”).

### 1. Big Data and Big Data Analytics

Big Data Analytics problems are often defined as the ones that involve Big Data Volume, Big Data Velocity, and/or Big Data Variation [2].

Big Data Volume may be due to large numbers of variables, or big numbers of observed instances (objects or units of analysis), or both.

Big Data Velocity may be due to the speed via which data is produced (e.g., real time imaging or sensor data, or online digital content), or the high speed of analysis (e.g., real-time threat detection in defense applications, online fraud detection, digital advertising routing, high frequency trading, etc.).

Big Data Variation refers to datasets and corresponding fields where the data elements, or units of observations can have large variability that makes analysis hard. For example, in medicine one variable (diagnosis) may take thousands of values that can further be organized in interrelated hierarchically organized disease types.

According to another definition, the aspect of data analysis that characterizes Big Data Analytics problems is its overall difficulty relative to current state of the art analytic capabilities. A broader definition of Big Data Analytics problems is thus adopted by some (e.g., the National Institutes of Health (NIH)), to denote all analysis situations that press the boundaries or exceed the capabilities of the current state of the art in analytics systems and technology. According to this definition, “hard” analytics problems are de facto part of Big Data Analytics [3].

### 2. Types of Data Analysis

The main types of Plata analytics [4] are:

a. Classification for Diagnostic or Attribution Analysis: where a typically computer-implemented system produces a table of assignments of objects into predefined categories on the basis of object characteristics.
Examples: medical diagnosis; email spam detection; separation of documents as responsive and unresponsive in litigation.

b. Regression for Diagnostic Analysis: where a typically computer-implemented system produces a table of assignments of numerical values to objects on the basis of object characteristics.
Examples: automated grading of essays; assignment of relevance scores to documents for information retrieval; assignment of probability of fraud to a pending credit card transaction

c. Classification for Predictive Modeling: where a typically computer-implemented system produces a table of assignments of objects into predefined categories on the basis of object characteristics and where values address future states (i.e., system predicts the future).
Examples: expected medical outcome after hospitalization; classification of loan applications as risky or no with respect to possible future default; prediction of electoral results.

d. Regression for Predictive Modeling: where a typically computer-implemented system produces a table of assignments of numerical values to objects on the basis of object characteristics and where values address future states (i.e., system predicts the future
Examples: predict stock prices at a future time; predict likelihood for rain tomorrow; predict likelihood for future default on a loan.

e. Explanatory Analysis: where a typically computer-implemented system produces a table of effects of one or more factors on one or more attributes of interest; also producing a catalogue of patterns or rules of influences.
Examples: analysis of the effects of sociodemographic features on medical service utilization, political party preferences or consumer behavior.

f. Causal Analysis: where atypically computer-implemented system produces a table or graph of causes-effect relationships and corresponding strengths of causal influences describing thus how specific phenomena causally affect a system of interest.
Example: causal graph models of how gene expression of thousands of genes interact and regulate development of disease or response to treatment; causal graph models of how socioeconomic factors and media exposure affect consumer propensity to buy certain products; systems that optimize the number of experiments needed to understand the causal structure of a system and manipulate it to desired states.

g. Network Science Analysis: where atypically computer-implemented system produces a table or graph description of how entities in a big system inter-relate and define higher level properties of the system. Example: network analysis of social networks that describes how persons interrelate and can detect who is married to whom; network analysis of airports that reveal how the airport system has points of vulnerability (i.e., hubs) that are responsible for the adaptive properties of the airport transportation system (e.g., ability to keep the system running by rerouting flights in case of an airport closure).

h. Feature selection dimensionality reduction and data compression: where a typically computer-implemented system selects and then eliminates all variables that are irrelevant or redundant to a classification/regression, or explanatory or causal modeling (feature selection) task; or where such as system reduces a large number of variables to a small number of transformed variables that are necessary and sufficient for classification/regression, or explanatory causal modeling (dimensionality reduction or data compression).
Example: in order to perform web classification into family-friendly ones or not, web site contents are first cleared of all words or content that is not necessary for the desired classification.

i. Subtype and data structure discovery: where analysis seeks to organize objects into groups with similar characteristics or discover other structure in the data.
Example: clustering of merchandize such that items grouped together are typically being bought together; grouping of customers into marketing segments with uniform buying behaviors.

j. Feature construction: where atypically computer-implemented system pre-processes and transforms variables in ways that enable the other goals of analysis. Such pre-processing may be grouping, abstracting, existing features or constructing new features that represent higher order relationships, interactions etc.
Example: when analyzing hospital data for predicting and explaining high-cost patients, co-morbidity variables are grouped in order to reduce the number of categories from thousands to a few dozen which then facilitates the main (predictive) analysis; in algorithmic trading, extracting trends out of individual time-stamped variables and replacing the original variables with trend information facilitates prediction of future stock prices.

k. Data and analysis parallelization, chunking, and distribution: where a typically computer-implemented system performs a variety of analyses (e.g., predictive modeling, diagnosis, causal analysis) using federated databases, parallel computer systems, and modularizes analysis in small manageable pieces, and assembles results into a coherent analysis.
Example: in a global analysis of human capital retention a world-wide conglomerate with 2,000 personnel databases in 50 countries across 1,000 subsidiaries, can obtain predictive models for retention applicable across the enterprise without having to create one big database for analysis.

Important note about terminology: in common everyday use (e.g., in common parlance, in the business analytics and even in parts of the scientific and technical literature) the term “predictive modeling” is used as general-purpose term for all analytic types a, b, c, d, e without discrimination. This is for narrative convenience since it is much less cumbersome to state, for example, that “method X is a predictive modeling method” as opposed to the more accurate but inconvenient “method X is a method that can be used for Classification for Diagnostic or Attribution Analysis, and/or Regression for Diagnostic Analysis, and/or Classification for Predictive Modeling, and/or Regression for Predictive Modeling, and/or Explanatory Analysis”. In those cases it is inferred from context what is the precise type of analysis that X is intended for or was used etc.

The present application utilizes this simplifying terminological convention and refers to “predictive modeling” as the application field of the invention to cover analysis types a, b, c, d, and e.

### 3. Specific Examples of Data Analytics Application Areas

The following Listing provides examples of some of the major fields of application for the invented system specifically, and Data Analytics more broadly [5]:

1. Credit risk/Creditworthiness prediction.

2. Credit card and general fraud detection.

3. Intention and threat detection.

4. Sentiment analysis.

5. Information retrieval, filtering, ranking, and search.

6. Email spam detection.

7. Network intrusion detection.

8. Web site classification and filtering.

9. Matchmaking.

10. Predict success of movies.

11. Police and national security applications

12. Predict outcomes of elections.

13. Predict prices or trends of stock markets.

14. Recommend purchases.

15. Online advertising.

16. Human Capital/Resources: recruitment, retention, task selection, compensation.

17. Research and Development.

18. Financial Performance.

19. Product and Service Quality.

20. Client management (selection, loyalty, service).

21. Product and service pricing.

22. Evaluate and predict academic performance and impact.

23. Litigation: predictive coding, outcome/cost/duration prediction, bias of courts, voire dire.

24. Games (e.g., chess, backgammon, jeopardy).

25. Econometrics analysis.

26. University admissions modeling.

27. Mapping fields of activity.

28. Movie recommendations.

29. Analysis of promotion and tenure strategies,

30. Intension detection and lie detection based on fMRI readings.

31. Dynamic Control (e.g., autonomous systems such as vehicles, missiles; industrial robots; prosthetic limbs).

32. Supply chain. management.

33. Optimizing medical outcomes, safety, patient experience, cost, profit margin in healthcare systems.

34. Molecular profiling and sequencing based diagnostics, prognostics, companion drugs and personalized medicine.

35. Medical diagnosis, prognosis and risk assessment.

36. Automated grading of essays.

37. Detection of plagiarism.

38. Weather and other physical phenomena forecasting.

The present invention in particular addresses the following aspects of data design, an essential step in every data analytic system, method and application. Specifically, an important consideration when designing data collection requirements for training a predictive or causal model is how much sample size is needed to train and test the models. The factors that affect the needed sample size are:

1. The desired final model performance (i.e., predictivity or other performance metric such as accuracy of causal identification for causal models). Everything else being equal, the higher the required performance the model should have, the more sample should be used for training.

2. The achievable final model performance. Although for example in some predictive modeling application one may desire predictivity P1, only P2<P1 may be feasible for the modeling problem at hand. Thus beyond P2, desired predictivity seizes to affect sample size requirements.

3. The convergence rate of the inductive method used to model the data to achieve the desired achievable final model performance as a function of sample size. Everything else being equal, the slowest the convergence, the larger the required sample size. This is also known as the sample efficiency function of the learner method for the target function to be learned. Everything else being equal, the more complex a function one wishes to learn the slower will be the convergence and larger the required sample size.

4. The probability of the rarest value of the response variable (assuming sample is collected randomly). Everything else being equal, the rarer the rarest value of the response variable is, the more sample is needed for training In causal modeling situations response variables are all variables for which one wishes to determine causes and effects.

5. The desired statistical certainty for estimating model performance. Everything else being equal, the more certain one wishes to be about the achieved predictivity, the larger the sample size needed for training and for validating the model.

Established methods for statistical “power-size” analysis for statistical modeling allow an analyst to answer the following fundamental data design questions:
“If my client wishes models with predictivity P, and also wishes to estimate this predictivity with statistical certainty y (e.g., with 95% confidence interval) then how much sample size do I need to collect for training?”.
“If my protocol for validating the predictivity of the above model with delta d, power p and alpha a, then how large must my validation set be?”. Where a is the probability for falsely concluding that the model's error in the validation set is different than in error estimate established at training by more than d, and p is the probability for detecting a true difference when it exists.

The above methodological tools useful as they are for statistical hypothesis testing , have serious shortcomings in modern data analytics scenarios. In modern complex predictive and causal modeling applications the determination of sample size is also affected by the achieveable final model performance and the convergence rate as explained above, so standard statistical power-size analysis cannot help answer the question of how much sample is needed in order to build a sufficiently powerful model.

The present invention provides a method and computer-implemented system for determining sufficient sample size for training predictive or causal models for a given prior distribution and desired performance level taking into account all factors that affect the needed sample size.

In addition the invention addresses another important shortcoming of standard statistical power-size analysis tools: such tools are based on asymptotic sampling theory whereas in many practical applications there is no well-developed sampling theory (and corresponding closed-formula solutions) to inform the determination of minimal sample needed. Instead the invention relies on empirical means in the form of a database of pre-analyzed datasets that broadly cover the domain of application.

The invention can be applied to practically any field where predictive modeling (with the expanded meaning defined earlier) or causal modeling are desired. Because it relies on first building empirical field-specific databases, it is application field-neutral (i.e., it is applicable across all fields) as long as such databases have been prepared prior to analysis.

### BRIEF DESCRIPTION OF THE FIGURES

FIG. 1 shows experimental results after performing the method using the 5^{th} percentile of distributions for performance.

FIG. 2 shows experimental results after performing the method using the 10^{th} percentile of distributions for performance.

FIG. 3 shows the organization of a general-purpose modern digital computer system such as the ones used for the typical implementation of the invention.

### DETAILED DESCRIPTION OF THE INVENTION

The method assumes that there is a data distribution D for which an analyst or an automated analysis system need determine an adequate random sample size for predictive or causal modeling training purposes. Inputs to the method are the known or estimated prior distribution P of the target response variable in D, desired certainty level L, and desired performance A0. The method comprises of the following series of steps organized in three phases:

### Preparatory Phase—Knowledge Base Creation:

1. Compile a collection of datasets that have a variety of prior distributions for the target class and are otherwise broadly representative of the types of data relevant to the modeling to be accomplished.

2. For every dataset in the dataset collection, generate random samples of increasing sample sizes. For example, for starting point of sample size 100 with 1000 repeats, this process would give 1000 randomly sampled data sets of sample size 100 for every one of the data sets in the knowledge base. Then, perform this repeated random sampling for several increasing sample sizes (e.g., 100, 150, 200, . . . , total available sample) and all datasets in the knowledge base.

3. For each pair {random sample, dataset}, train a model using the learning method(s) of choice and estimate performance (e.g., train classifier models and estimate generalization error using 5-fold cross validation). Repeat for all samples and all sample sizes within a range that reflects the realistically obtainable sample sizes for this application field and type of analysis. Save performance values of each of the samples for all sample sizes.

### Analysis Phase Part 1:

1. Select a subset of the datasets from the knowledge base that have prior approximately equal to prior distribution P.

2. Examine the distribution of performances for the datasets selected in step 1. Determine the minimal sample size S1 such that at least L in the distribution of performances have desired performance A0 or better.

3. Obtain a random sample of size S1 from D.

4. Train a model and estimate performance by using cross-validation or other appropriate performance estimators. A1 is the current performance estimate.

5. If A1>=A0, train the classifier in all labeled data from TRAIN, output the model, and terminate.

Analysis Phase Part 2 is entered if A1 is less than A0 in Analysis Phase Part 1 as determined by standard statistical testing of A1 against A0.

### Analysis Phase Part 2:

1. Select the subset of the datasets from the knowledge base that have prior approximately equal to (i.e., statistically indistinguishable from) the prior distribution P and have performance A1 at sample size S1.

2. Find the smallest sample size S2>S1 that achieves performance=A0 in at least L of the datasets identified in the previous step.

3. Obtain a random sample of data from D of sample size S2.

4. Train a model and estimate performance by using cross-validation or other appropriate estimators. A2 is the current performance estimate.

5. If A2>=A0, train the classifier in all labeled data from TRAIN, output the model, and terminate.

6. If A2<A0 then reiterate Phase 2 using the new performance estimate A2 instead of A1 until A0 is reached or until a maximum number of iterations is carried out or until there are no datasets left in step 1.

A variant of the method instead of storing all datasets of varying random down-samples and corresponding performance estimates, explicitly models the convergence rate of the learners using regression or other standard function approximation methods. The advantages of this approach is that whenever such a model can be fit to the data, it will allow for statistical smoothing and generalization (intra- and extrapolation) of the convergence data. It also allows for explicit modeling of additional modeling parameters on the observed performance variability to better match the analysis requirements and setup.

Another variant of the method does not select datasets in step 1 that match the requisite performance level A0 with certainty L, but uses alternative statistical decision rules, such as calculating the average performances for every sample size cutoff, or choosing the smallest sample size that minimizes maximum risk, or weighs the expected performance of models using the posterior probability of the corresponding model, or the using the likelihood of the model given the corresponding sample size etc.

Another variant of the method instead of entering phase 2 relaxes incrementally L, or A0 until modeling is successful or until L or A0 cannot be relaxed further while being acceptable to the analyst.

A final variant of the method estimates in addition to the necessary sample Si needed for learning a model with performance at least A0, the necessary sample Stest for rejecting the hypothesis A0=A1. In this variant the maximum of the Si and Stest is output as the necessary sample size for the analysis.

### Experimental Demonstration of the Method:

The method is implemented in general purpose computer. A large-scale experimental analysis was performed to verify and demonstrate it in the context of a large evaluation study of text classification [6]. 221 datasets were selected from the UCI Machine Learning Repository and other publically available data sources. 59 sample sizes were chosen (100, 150, 200, . . . , 3000), and 100 random samples were taken for each sample size and each dataset. Prior distributions of 0.01, 0.05, 0.1, 0.15, 0.2, and 0.25 were used. AUC was the performance metric used to build the Knowledge Base. The method can be used with other metrics such as precision, recall, or f-measure as explained. We report experimental results with the method performed for predictive modeling (a) in its standard configuration described above and (b) in the variant that relaxes L.

Results: approximately 8 million models were built and evaluated using cross validation in the Knowledge Base Preparation Phase.

FIG. 1 shows the sample sizes that are required for given values of prior distribution and desired performance at an L=95%.

For example, the Knowledge Base produced in the preparatory phase of the inventive method's experimental demonstration contains multiple datasets that satisfy the requirement for at least 95% of models achieving cross-validated AUC of 0.7 or better when the prevalence of the positive class is P=10%. Also the top left cell in FIG. 1 means that for a prevalence of the positive class of 0.01 and desired performance of AUC=0.7, with L 95%, a training set of 100 samples is sufficient. Empty cells signify that the desired performance was not achieved at the desired L with the included datasets.

It is also evident from FIG. 1 that in the application domain captured by this Knowledge Base it is not possible to obtain models with AUC 0.9 or better, 95% of the time when the prevalence is 15% and sample size 400. The smallest sample size required for modeling under those conditions is 1000.

In a run of the method with analysis targets: A0=0.85 AUC, L=95%, P=0.1 it was verified that in at least 95 out of 100 random samples of size 400 achieved cross validated AUC of 0.85 or better (analysis phase I).

Phase 2 of the method is designed to address situations where the Knowledge Base is an approximate representation of the data to be analyzed (otherwise it is not possible to reach phase 2 by means other than an unlucky random sample where such risk can be eliminated by setting L to 100%). Since we were using only datasets from the same set of datasets used for building the Knowledge Base all performances A1<A0 were not statistically significant and thus Phase 2 was correctly terminated.

In an additional test of the method with analysis targets: A0=0.85 AUC, L=90%, P=0.1 it was verified that in at least 90 out of 100 random samples of size 350 achieved cross validated AUC of 0.85 or better (analysis phase I) as predicted by the Knowledge Base and demonstrated in FIG. 2 that shows the sample sizes that are required for predictive modeling for given values of prior distribution and desired performance at L=90%.

### Method and System Output, Presentation, Storage and Transmittance

The relationships, correlations, and significance (thereof) discovered by application of the method of this invention may be output as graphic displays (multidimensional as required), probability plots, linkage/pathway maps, data tables, and other methods as are well known to those skilled in the art. For instance, the structured data stream of the method's output can be routed to a number of presentation, data/format conversion, data storage, and analysis devices including but not limited to the following: (a) electronic graphical displays such as CRT, LED, Plasma, and LCD screens capable of displaying text and images; (b) printed graphs, maps, plots, and reports produced by printer devices and printer control software; (c) electronic data files stored and manipulated in a general purpose digital computer or other device with data storage and/or processing capabilities; (d) digital or analog network connections capable of transmitting data; (e) electronic databases and file systems. The data output is transmitted or stored after data conversion and formatting steps appropriate for the receiving device have been executed.

### Software and Hardware Implementation

Due to large numbers of data elements in the datasets, which the present invention is designed to analyze, the invention is best practiced by means of a general purpose digital computer with suitable software programming (i.e., hardware instruction set) (FIG. 3 describes the architecture of modern digital computer systems). Such computer systems are needed to handle the large datasets and to practice the method in realistic time frames. Based on the complete disclosure of the method in this patent document, software code to implement the invention may be written by those reasonably skilled in the software programming arts in any one of several standard programming languages including, but not limited to, C, Java, and Python. In addition, where applicable, appropriate commercially available software programs or routines may be incorporated. The software program may be stored on a computer readable medium and implemented on a single computer system or across a network of parallel or distributed computers linked to work as one. To implement parts of the software code, the inventors have used MathWorks Matlab® and a personal computer with an Intel Xeon CPU 2.4 GHz with 24 GB of RAM and 2 TB hard disk.

### REFERENCES

1. Davenport T H, Harris J G: Competing on analytics: the new science of winning: Harvard Business Press; 2013.
2. Douglas L: The Importance of ‘Big Data’: A Definition. Gartner (June 2012) 2012.
3. NIH Big Data to Knowledge (BD2K) [http://bd2k.nih.gov/about_bd2k.html#bigdata]
4. Provost F, Fawcett T: Data Science for Business: What you need to know about data mining and data-analytic thinking: “ O'Reilly Media, Inc.”; 2013.
5. Siegel E: Predictive Analytics: The Power to Predict Who Will Click, Buy, Lie, or Die: John Wiley & Sons; 2013.
6. Aphinyanaphongs Y, Fu L D, Li Z, Peskin E R, Efstathiadis E, Aliferis C F, Statnikov A: A comprehensive empirical comparison of modern supervised classification and feature selection methods for text categorization. Journal of the Association for Information Science and Technology 2014.

We claim:

1. A computer-implemented method and system for determining sample size and power required for complex predictive and causal data analysis comprising the following steps:
a) accepting as inputs a dataset D, the known or estimated prior distribution P of the target response variable in D, a desired performance A0 and a desired certainty level L that the desired performance will be attained by analyzing D with the sample size recommended by the system;
b) a preparatory phase of knowledge base creation consisting of:
1) compiling a collection of datasets that have a variety of prior distributions for the target class and are otherwise broadly representative of the types of data relevant to the modeling to be accomplished;
2) for every dataset in the dataset collection, generating random samples of increasing sample sizes;
3) for each random sample training a model using the learning method(s) of choice and estimating performance;
4) saving performance values of each of the samples for all sample sizes;
c) a first part analysis phase consisting of:
1) selecting a subset of the datasets from the knowledge base that have prior approximately equal to prior distribution P;
2) examining the distribution of performances for the datasets selected in step c.1 to determine the minimal sample size S1 such that at least L % datasets have desired performance A0 or better;
3) obtaining a random sample TRAIN of size S1 from D;
4) training a model and estimating performance A1 by cross-validation of other performance estimators;
5) if A1>=A0, training the classifier in all labeled data in TRAIN and outputting the model, and terminating;
d) a second-part analysis phase that is activated if A1 in the first-part analysis phase is less than A0, and comprising:
1) selecting the subset of the datasets from the knowledge base that have prior equal to the prior distribution P and having performance A1 at sample size S1;
2) finding the smallest sample size S2>S1 that achieves performance=A0 in at least L of the datasets identified in step d.1;
3) obtaining a random sample TRAIN of data from D of sample size S2;
4) training a model and estimating performance A2 by using cross-validation of other performance estimators;
5) if A2>=A0, training the classifier in all labeled data from TRAIN, outputting the model, and terminating; and
6) if A2<A0 then reiterating second-part analysis from step d.1 using the new performance estimate A2 instead of A1 until A0 is reached or until a maximum number of iterations is carried out or until there are no datasets left in step d.1.

2. The computer-implemented method and system of claim 1 in which instead of storing all datasets of varying random down-samples and corresponding performance estimates, a model of the convergence rate of the learners is fit using regression or other standard function approximation methods.

3. The computer-implemented method and system of claim 1 in which instead of entering the second-part analysis phase d, the method relaxes incrementally L, or A0 until modeling is successful or until L or A0 cannot be relaxed further and continue being acceptable to the analyst.

4. The computer-implemented method and system of claim 1 in which in addition to the necessary sample Si needed for learning a model with performance at least A0, the necessary sample Stest for rejecting the hypothesis A0=A1 is calculated, using standard power-size analysis, and then the maximum of the Si and Stest is output as the necessary sample size for the analysis.
